(19) United States
(12) Patent Application Publication
(10) Pub. No.: US 2025/0248430 A1
(43) Pub. Date: Aug. 7, 2025

(54) METHOD OF ENHANCING EGG YOLK LIPID HYDROLYZATION

(71) Applicant: Michael Foods, Inc., Hopkins, MN (US)

(72) Inventor: Siquan Li, Gaylord, MN (US)

(73) Assignee: Michael Foods, Inc., Hopkins, MN (US)

(21) Appl. No.: 19/045,384

(22) Filed: Feb. 4, 2025

Related U.S. Application Data
(60) Provisional application No. 63/549,968, filed on Feb. 5, 2024.

(51) Int. Cl. A23L 15/00; A23B 5/035; A23L 27/40

(52) U.S. Cl. CPC A23L 15/25; A23B 5/035; A23L 27/45

(57) ABSTRACT

The present disclosure relates to improved methods for the enzymatic hydrolysis of phospholipids in egg yolks. Phospholipase A2 enzymes hydrolyze egg yolk phospholipids at the sn-2 fatty ester group to liberate the corresponding free fatty acids. The rate of enzymatic hydrolysis and the degree to which free fatty acids are liberated can be increased by addition of one or more calcium salts. The use of calcium salts to increase egg yolk phospholipid hydrolysis rate decreases production costs, decreases processing and production times, and increases process safety by reducing microbial content in enzyme-modified egg yolks.

### CROSS REFERENCE TO RELATED APPLICATIONS

This application claims priority to U.S. Provisional Application Ser. No. 63/549,968, filed Feb. 5, 2024, which is incorporated by reference herein in its entirety.

### TECHNICAL FIELD

The present disclosure relates to methods for processing of egg yolks. More specifically, the present disclosure relates to methods for improving phospholipase activity during production of enzyme-modified egg yolks.

### BACKGROUND

Increased consumer awareness of diet and its contribution of to a healthy lifestyle has led to an increased focus on the nutritional value of certain foods such as eggs. Egg yolk, in particular, is a highly nutritional food ingredient that contains digestible proteins, vitamins, minerals, phospholipids, lutein, and other nutrients. In addition to direct consumption, egg yolk is a major ingredient for a variety of food products due to its high nutritional value and its ability to alter physicochemical properties of foods, including its ability to gel, facilitate emulsion formation, and provide a desired creamy mouthfeel and rich flavors.

Egg yolk is a natural emulsifier and used in many food products such as ice cream, mayonnaise, and dressings. In many of its applications, higher emulsification capacity is desired to improve the quality of finished goods and to reduce processing costs to provide larger commercial margins to manufacturers.

To improve the emulsification capacity of egg yolk for more efficient food product formulation, a range of modification techniques have been developed. These modification techniques can change the physicochemical properties of egg yolk components by affecting the viscosity, molecular weights and structures, and interactions of egg yolk components with surrounding functional food product components, thereby improving physicochemical and sensory characteristics of the food products.

One type of egg yolk modification that is used to alter its physicochemical properties is enzymatic hydrolysis. Enzymes can be used to hydrolyze or cleave various functional groups by effectively adding water across a covalent chemical bond within the functional group. Enzymes like proteases, esterases, and lipases can hydrolyze different types of molecules within egg yolks. Phospholipases, in particular, hydrolyze a chemical functional group within phospholipids, and different phospholipid subtypes can selectively hydrolyze a specific functional group within a phospholipid. Among these, phospholipase A2 (PLA2) enzyme modification of phospholipids, or partial hydrolysis of egg yolk lipids, is the most well recognized method to improve the emulsification properties of egg yolk. PLA2 selectively hydrolyzes the fatty ester group at the sn-2 position of phospholipid molecules, thereby converting phospholipids into lyso-phospholipids, which are in a more hydrophilic state due to fatty acid removal. Processing with PLA2 can improve the emulsifying ability of egg yolks by improving phospholipid molecular flexibility, thereby improving lipid coating efficiency and affinity when coated onto fat globule surfaces. This improved emulsification capacity of PLA2-hydrolyzed phospholipids can improve the capacity of oil-in-water emulsions to hold oil and achieve finer fat particle size and can improve the stability of the resultant emulsion against heat, temperature fluctuation, pressure, vibration, or other factors that may affect emulsion stability.

Current PLA2-processing practice in commercial production of enzyme-modified yolk products involves hydrolysis of egg yolk phospholipids with PLA2 at 48.9° C. or greater for up to 7 to 12 hours. The long exposure of egg yolk to the elevated temperature can significantly increase the risk of microorganism growth, reduce production throughput, and drive process costs up. Salt (sodium chloride) may be added to marginally improve these aforementioned concerns, but sodium chloride is not appropriate for products in which a low final salt concentration is desired, such as cake, ice cream, bread, etc. Accordingly, there is a need in the industry for alternative methods to increase the rate of enzyme-mediated hydrolysis of egg yolk phospholipids to improve physicochemical and sensory characteristics.

### SUMMARY

The present disclosure describes a solution to at least some of the problems associated with enzyme-mediated hydrolysis of egg yolk phospholipids. The solution resides in the use of calcium salts to increase the rate of PLA2 hydrolysis of egg yolk phospholipids. Several advantages can be realized when employing calcium salts to increase the rate of PLA2 hydrolysis. Because the rate of egg yolk hydrolyzation is increased, the total amount of processing time is reduced, which reduces overall manufacturing costs. Fewer tests are required to monitor fatty acid levels during processing when enzyme-modified hydrolyzed egg yolk production time is reduced. This also leads to reduced costs associated with a reduction of silo (or other receptacle) occupation time, energy needed to maintain yolk temperature, and reduced labor. Because the time to produce enzyme-modified egg yolks is reduced, a concomitant increase in production throughput is achieved. Additionally, the reduction in processing time leads to improved process control and reduced microbiological risks because microbes have less time to grow and multiply. Finally, when viewed from a regulatory perspective, less product waste is produced per time allowance window. The end result is a faster, safer, and more profitable hydrolyzed egg yolk production process that culminates in a product with enhanced physicochemical and sensory characteristics.

Accordingly, some aspects of the disclosure are directed to a method of producing enzyme-modified egg yolk comprising incubating a phospholipase, a calcium salt, and egg yolk for a time sufficient to hydrolyze phospholipids in the egg yolk to produce the enzyme-modified egg yolk. Hydrolysis of egg yolk phospholipids occurs through hydrolysis of a phospholipid fatty ester group to provide the corresponding free fatty acid and isophospholipids. Therefore, the degree to which egg yolk phospholipids in a sample are hydrolyzed can be determined by measuring free fatty acid concentration in the sample.

In some aspects, the phospholipase, calcium salt, and egg yolk are incubated together to induce hydrolysis of egg yolk phospholipids. In some aspects, the egg yolk is heated prior to incubating the phospholipase, the calcium salt, and the egg yolk. Prior to incubating the phospholipase, the calcium salt, and the egg yolk, the egg yolk can be heated at a temperature ranging from 55° C. to 67° C. for a period of time ranging from 2.0 min to 8.0 min. Prior to incubating the phospholipase, the calcium salt, and the egg yolk, the egg yolk can be heated at a temperature that is any one of, less than, greater than, between, or any range thereof of 55° C., 56° C., 57° C., 58° C., 59° C., 60° C., 61° C., 62° C., 63° C., 64° C., 65° C., 66° C., and 67° C. for a period of time that is any one of, less than, greater than, between, or any range thereof of 2 minutes, 2 minutes 15 seconds, 2 minutes 30 seconds, 2 minutes 45 seconds, 3 minutes, 3 minutes 15 seconds, 32 minutes 30 seconds, 3 minutes 45 seconds, 4 minutes, 4 minutes 15 seconds, 4 minutes 30 seconds, 4 minutes 45 seconds, 5 minutes, 5 minutes 15 seconds, 5 minutes 30 seconds, 5 minutes 45 seconds, 6 minutes, 6 minutes 15 seconds, 6 minutes 30 seconds, 6 minutes 45 seconds, 7 minutes, 7 minutes 15 seconds, 7 minutes 30 seconds, 7 minutes 45 seconds, and 8 minutes. In some aspects, the egg yolk is heated at temperature of 57° C. to 64° C. for 3.0 min to 7.0 min. In some aspects, the egg yolk is heated at temperature of 59° C. to 64° C. for 3.5 min to 5.5 min. In some aspects, prior to incubating the egg yolk with either or both of the phospholipase and the calcium salt, the egg yolk pH can be adjusted. In some aspects, the egg yolk pH is adjusted after heating the egg yolk and prior to incubating the egg yolk with either or both of the phospholipase and the calcium salt. The egg yolk pH can be adjusted to a pH that is any one of, less than, greater than, between, or any range thereof of 7.8, 7.85, 7.9, 7.95, 8.0, 8.05, and 8.1. In some aspects, the egg yolk pH is adjusted to a pH ranging from 7.8 to 8.1. In some aspects, the egg yolk pH is adjusted to a pH ranging from 7.95 to 8.05.

The phospholipase can be incubated with the calcium salt or with the egg yolk prior to incubating the phospholipase, the calcium salt, and the egg yolk together. The egg yolk can be incubated with the calcium salt or with the phospholipase prior to incubating the phospholipase, the calcium salt, and the egg yolk together. The calcium salt can be incubated with the phospholipase or with the egg yolk prior to incubating the phospholipase, the calcium salt, and the egg yolk together. In some aspects, a method of producing enzyme-modified egg yolk further comprises spray-drying or freezing the enzyme-modified egg yolk.

In some aspects, the phospholipase is incubated with the calcium salt prior to incubating the phospholipase, the calcium salt, and the egg yolk. In some aspects, the phospholipase is incubated with the calcium salt for 5 minutes to 120 minutes prior to incubating the phospholipase, the calcium salt, and the egg yolk. In some aspects, the phospholipase is incubated with the calcium salt for 10 minutes to 60 minutes prior to incubating the phospholipase, the calcium salt, and the egg yolk. In some aspects, the phospholipase is incubated with the calcium salt for 20 minutes to 30 minutes prior to incubating the phospholipase, the calcium salt, and the egg yolk. The phospholipase can be incubated with the calcium salt for a period of time that is any one of, less than, greater than, between, or any range thereof of 5, 10, 15, 20, 25, 30, 35, 40, 45, 50, 55, 60, 65, 70, 75, 80, 85, 90, 95, 100, 105, 110, 115, and 120 minutes. In some aspects, the phospholipase and the calcium salt are incubated together at a temperature that is any one of, less than, greater than, between, or any range thereof of 43° C., 44° C., 45° C., 46° C., 47° C., 48° C., 49° C., 50° C., 51° C., 52° C., 53° C., 54° C., 55° C., 56° C., 57° C., 58° C., 59° C., 60° C., 61° C., 62° C., 63° C., 64° C., 65° C., 66° C., 67° C., 68° C., 69° C., and 70° C.

In some aspects, the egg yolk is incubated with the calcium salt prior to incubating the phospholipase, the calcium salt, and the egg yolk. In some aspects, the egg yolk is incubated with the calcium salt for 5 minutes to 120 minutes prior to incubating the phospholipase, the calcium salt, and the egg yolk. In some aspects, the egg yolk is incubated with the calcium salt for 10 minutes to 60 minutes prior to incubating the phospholipase, the calcium salt, and the egg yolk. In some aspects, the egg yolk is incubated with the calcium salt for 20 minutes to 30 minutes prior to incubating the phospholipase, the calcium salt, and the egg yolk. The egg yolk can be incubated with the calcium salt for a period of time that is any one of, less than, greater than, between, or any range thereof of 5, 10, 15, 20, 25, 30, 35, 40, 45, 50, 55, 60, 65, 70, 75, 80, 85, 90, 95, 100, 105, 110, 115, and 120 minutes. In some aspects, the egg yolk and the calcium salt are incubated together at a temperature that is any one of, less than, greater than, between, or any range thereof of 43° C., 44° C., 45° C., 46° C., 47° C., 48° C., 49° C., 50° C., 51° C., 52° C., 53° C., 54° C., 55° C., 56° C., 57° C., 58° C., 59° C., 60° C., 61° C., 62° C., 63° C., 64° C., 65° C., 66° C., 67° C., 68° C., 69° C., and 70° C.

In some aspects, the egg yolk is incubated with the phospholipase prior to incubating the phospholipase, the calcium salt, and the egg yolk. In some aspects, the egg yolk is incubated with the phospholipase for 5 minutes to 120 minutes prior to incubating the phospholipase, the calcium salt, and the egg yolk. In some aspects, the egg yolk is incubated with the phospholipase for 10 minutes to 60 minutes prior to incubating the phospholipase, the calcium salt, and the egg yolk. In some aspects, the egg yolk is incubated with the phospholipase for 20 minutes to 30 minutes prior to incubating the phospholipase, the calcium salt, and the egg yolk. The egg yolk can be incubated with the phospholipase for a period of time that is any one of, less than, greater than, between, or any range thereof of 5, 10, 15, 20, 25, 30, 35, 40, 45, 50, 55, 60, 65, 70, 75, 80, 85, 90, 95, 100, 105, 110, 115, and 120 minutes. In some aspects, the phospholipase and the egg yolk are incubated together at a temperature that is any one of, less than, greater than, between, or any range thereof of 43° C., 44° C., 45° C., 46° C., 47° C., 48° C., 49° C., 50° C., 51° C., 52° C., 53° C., 54° C., 55° C., 56° C., 57° C., 58° C., 59° C., 60° C., 61° C., 62° C., 63° C., 64° C., 65° C., 66° C., 67° C., 68° C., 69° C., and 70° C.

In some aspects, the calcium salt is selected from the group consisting of calcium chloride, calcium acetate, calcium nitrate, calcium lactate, calcium glucoronate, and calcium bicarbonate. In some aspects, the calcium salt is periodically added to a combination of the egg yolk and the phospholipase. In other aspects, the calcium salt is continuously added to a combination of the egg yolk and the phospholipase. In some aspects, the calcium salt is added to egg yolk and/or the phospholipase at a calcium salt concentration that is any one of, less than, greater than, between, or any range thereof of 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, 10.0, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, 12.0, 12.1, 12.2, 12.3, 12.4, 12.5, 12.6, 12.7, 12.8, 12.9, 13.0, 13.1, 13.2, 13.3, 13.4, 13.5, 13.6, 13.7, 13.8, 13.9, 14.0, 14.1, 14.2, 14.3, 14.4, 14.5, 14.6, 14.7, 14.8, 14.9, 15.0, 15.1, 15.2, 15.3, 15.4, 15.5, 15.6, 15.7, 15.8, 15.9, 16.0, 16.1, 16.2, 16.3, 16.4, 16.5, 16.6, 16.7, 16.8, 16.9, 17.0, 17.1, 17.2, 17.3, 17.4, 17.5, 17.6, 117.7, 7.8, 17.9, 18.0, 18.1, 18.2, 18.3, 18.4, 18.5, 18.6, 18.7, 18.8, 18.9, 19.0, 19.1, 19.2, 19.3, 19.4, 19.5, 19.6, 19.7, 19.8, 19.9, 20.0, 20.1, 20.2, 20.3, 20.4, 20.5, 20.6, 20.7, 20.8, 20.9, 21.0, 21.1, 21.2, 21.3, 21.4, 21.5, 21.6, 21.7, 21.8, 21.9, 22.0, 22.1, 22.2, 22.3, 22.4, 22.5, 22.6, 22.7, 22.8, 22.9, 23.0, 23.1, 23.2, 23.3, 23.4, 23.5, 23.6, 23.7, 23.8, 23.9, 24.0, 24.1, 24.2, 24.3, 24.4, 24.5, 24.6, 24.7, 24.8, 24.9, 25.0, 25.1, 25.2, 25.3, 25.4, 25.5, 25.6, 25.7, 25.8, 25.9, 26.0, 26.1, 26.2, 26.3, 26.4, 26.5, 26.6, 26.7, 26.8, 26.9, 27.0, 27.1, 27.2, 27.3, 27.4, 27.5, 27.6, 27.7, 27.8, 27.9, 28.0, 28.1, 28.2, 28.3, 28.4, 28.5, 28.6, 28.7, 28.8, 28.9, 29.0, 29.1, 29.2, 29.3, 29.4, 29.5, 29.6, 29.7, 29.8, 29.9, 30.0, 30.1, 30.2, 30.3, 30.4, 30.5, 30.6, 30.7, 30.8, 30.9, 31.0, 31.1, 31.2, 31.3, 31.4, 31.5, 31.6, 31.7, 31.8, 31.9, 32.0, 32.1, 32.2, 32.3, 32.4, 32.5, 32.6, 32.7, 32.8, 32.9, 33.0, 33.1, 33.2, 33.3, 33.4, 33.5, 33.6, 33.7, 33.8, 33.9, 34.0, 34.1, 34.2, 34.3, 34.4, 34.5, 34.6, 34.7, 34.8, 34.9, 35.0, 35.1, 35.2, 35.3, 35.4, 35.5, 35.6, 35.7, 35.8, 35.9, 36.0, 36.1, 36.2, 36.3, 36.4, 36.5, 36.6, 36.7, 36.8, 36.9, 37.0, 37.1, 37.2, 37.3, 37.4, 37.5, 37.6, 37.7, 37.8, 37.9, 38.0, 38.1, 38.2, 38.3, 38.4, 38.5, 38.6, 38.7, 38.8, 38.9, 39.0, 39.1, 39.2, 39.3, 39.4, 39.5, 39.6, 39.7, 39.8, 39.9, 40.0, 40.1, 40.2, 40.3, 40.4, 40.5, 40.6, 40.7, 40.8, 40.9, 41.0, 41.1, 41.2, 41.3, 41.4, 41.5, 41.6, 41.7, 41.8, 41.9, 42.0, 42.1, 42.2, 42.3, 42.4, 42.5, 42.6, 42.7, 42.8, 42.9, 43.0, 43.1, 43.2, 43.3, 43.4, 43.5, 43.6, 43.7, 43.8, 43.9, 44.0, 44.1, 44.2, 44.3, 44.4, 44.5, 44.6, 44.7, 44.8, 44.9, 45.0, 45.1, 45.2, 45.3, 45.4, 45.5, 45.6, 45.7, 45.8, 45.9, 46.0, 46.1, 46.2, 46.3, 46.4, 46.5, 46.6, 46.7, 46.8, 46.9, 47.0, 47.1, 47.2, 47.3, 47.4, 47.5, 47.6, 47.7, 47.8, 47.9, 48.0, 48.1, 48.2, 48.3, 48.4, 48.5, 48.6, 48.7, 48.8, 48.9, 49.0, 49.1, 49.2, 49.3, 49.4, 49.5, 49.6, 49.7, 49.8, 49.9, and 50 mM in order to incubate the egg yolk and/or the phospholipase with the calcium salt. In some aspects, the enzyme-modified egg yolk is dried to provide dried enzyme-modified egg yolk. In some aspects, the enzyme-modified egg yolk (e.g., dried enzyme-modified egg yolk) contains greater than or equal to 320 mg of calcium per 100 g of the enzyme-modified egg yolk (e.g., dried enzyme-modified egg yolk). In some aspects, the enzyme-modified egg yolk (e.g., dried enzyme-modified egg yolk) contains up to 1,000 mg of calcium per 100 g of the enzyme-modified egg yolk (e.g., dried enzyme-modified egg yolk). In some aspects, the enzyme-modified egg yolk (e.g., dried enzyme-modified egg yolk) includes any one of, less than, greater than, between, or any range thereof of 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, and 1,000 mg of calcium per 100 g of the enzyme-modified egg yolk (e.g., dried enzyme-modified egg yolk).

In some aspects, the phospholipase, the calcium salt, and the egg yolk are incubated together at a temperature greater than ambient temperature for a period of time sufficient to allow the phospholipase to hydrolyze egg yolk phospholipids and generate free fatty acids. In some aspects, phospholipase, the calcium salt, and the egg yolk are incubated together at a temperature of 43° C. to 55° C. for 1 hour to 6 hours. In some aspects, the phospholipase, the calcium salt, and the egg yolk are incubated together at a temperature that is any one of, less than, greater than, between, or any range thereof of 43° C., 44° C., 45° C., 46° C., 47° C., 48° C., 49° C., 50° C., 51° C., 52° C., 53° C., 54° C., and 55° C. for a period of time that is any one of, less than, greater than, between, or any range thereof of 1 hour, 1 hour 15 minutes, 1 hour 30 minutes, 1 hour 45 minutes, 2 hours, 2 hours 15 minutes, 2 hours 30 minutes, 2 hours 45 minutes, 3 hours, 3 hours 15 minutes, 3 hours 30 minutes, 3 hours 45 minutes, 4 hours, 4 hours 15 minutes, 4 hours 30 minutes, 4 hours 45 minutes, 5 hours, 5 hours 15 minutes, 5 hours 30 minutes, 5 hours 45 minutes, and 6 hours. In some aspects, the phospholipase, the calcium salt, and the egg yolk are incubated together at a temperature of 46° C. to 52° C. for 2 hour to 5 hours. In some aspects, the phospholipase, the calcium salt, and the egg yolk are incubated together at a temperature of 48° C. to 50° C. for 2 hour to 4 hours.

In some aspects, a method of producing enzyme-modified egg yolk further comprises deactivating the phospholipase after incubation with the calcium salt and egg yolk. The phospholipase can be deactivated based upon a determination of the degree to which fatty ester groups have been hydrolyzed thereby liberating free fatty acids from the egg yolk phospholipids. In some aspects, the phospholipase can be deactivated when fatty acid concentration reaches a pre-determined level. In some aspects, the phospholipase is deactivated after the egg yolk includes greater than or equal to 2% (w/w) free fatty acids. In some aspects, the phospholipase is deactivated based on a determination that the egg yolk includes greater than or equal to 2% (w/w) free fatty acids. In some aspects, the phospholipase is deactivated after the egg yolk reaches a free fatty acid concentration of 2% (w/w). In some aspects, the phospholipase is deactivated by refrigeration or freezing. In some aspects, the phospholipase is deactivated by increasing the temperature of a composition containing the phospholipase to a temperature that is greater than the phospholipase denaturing temperature. In some aspects, the phospholipase is deactivated by reducing the pH of a composition containing the phospholipase to a pH that is selected to reduce phospholipase activity. In some aspects, the phospholipase is deactivated by reducing the temperature of a mixture comprising the phospholipase and/or calcium salt and/or egg yolk to a temperature ranging from 0° C. to 8° C. The phospholipase can be deactivated by cooling a mixture comprising the phospholipase to a temperature that is any one of, less than, greater than, between, or any range thereof of 0, 1, 2, 3, 4, 5, 6, 7, and 8° C. In some aspects, the enzyme is deactivated by heating. In some aspects, the phospholipase is deactivated by maintaining the yolk at a temperature of from about 68° C. to about 75° C. for a period of time ranging from about 150 to about 600 seconds. The phospholipase can be deactivated by heating to a temperature that is any one of, less than, greater than, between, or any range thereof of 150, 151, 152, 153, 154, 155, 156, 157, 158, 159, 160, 161, 162, 163, 164, 165, 166, and 167° C. for a period of time that is any one of, less than, greater than, between, or any range thereof of 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350, 355, 360, 365, 370, 375, 380, 385, 390, 395, 400, 405, 410, 415, 420, 425, 430, 435, 440, 445, 450, 455, 460, 465, 470, 475, 480, 485, 490, 495, 500, 505, 510, 515, 520, 525, 530, 535, 540, 545, 550, 555, 560, 565, 570, 575, 580, 585, 590, 595, and 600 seconds.

Some aspects of the present disclosure are directed to an enzyme-modified egg yolk produced according to a method as disclosed herein. In some aspects, the enzyme-modified egg yolk includes greater than or equal to 2% (w/w) free fatty acids and greater than or equal to 320 mg of calcium per 100 g of the enzyme-modified egg yolk. In some aspects, the enzyme-modified egg yolk includes from 2% (w/w) free fatty acids to 100% (w/w) free fatty acids. In some aspects, the enzyme-modified egg yolk includes from 2% (w/w) free fatty acids to 25% (w/w) free fatty acids. In some aspects, the enzyme-modified egg yolk includes at least, at most, exactly, or between any two of 2, 3, 4, 5, 6, 7, 8, 9, 10, 11, 12, 13, 14, 15, 16, 17, 18, 19, 20, 21, 22, 23, 24, or 25 percent (w/w) free fatty acids. Some aspects of the disclosure are directed to a food product comprising an enzyme-modified egg yolk as disclosed herein.

The claims are not intended to include, and should not be interpreted to include, means plus- or step-plus-function limitations, unless such a limitation is explicitly recited in a given claim using the phrase(s) “means for” or “step for,” respectively.

The use of the term “or” in the claims is used to mean “and/or” unless explicitly indicated to refer to alternatives only or the alternative are mutually exclusive, although the disclosure supports a definition that refers to only alternatives and “and/or.” The phrase “and/or” means “and” or “or”. To illustrate, A, B, and/or C includes: A alone, B alone, C alone, a combination of A and B, a combination of A and C, a combination of B and C, or a combination of A, B, and C.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, the compositions and methods of the present disclosure that “comprise,” “have,” “include” or “contain” one or more elements possesses those one or more elements, but are not limited to possessing only those one or more elements. Likewise, an element of a composition or method of the present disclosure that “comprises,” “has,” “includes” or “contains” one or more features possesses those one or more features, but is not limited to possessing only those one or more features.

Any embodiment of the compositions and methods of the present disclosure can consist of or consist essentially of—rather than comprise/include/contain/have-any of the described elements and/or features and/or steps. Thus, in any of the claims, the term “consisting of” or “consisting essentially of” can be substituted for any of the open-ended linking verbs recited above, in order to change the scope of a given claim from what it would otherwise be using the open-ended linking verb. Compositions and methods “consisting essentially of” any of the elements or steps disclosed limits the scope of the claim to the specified materials or steps which do not materially affect the basic and novel characteristic of the claimed disclosure. The words “consisting of” (and any form of consisting of, such as “consist of” and “consists of”) means including, and limited to, whatever follows the phrase “consisting of.” Thus, the phrase “consisting of” indicates that the listed elements are required or mandatory, and that no other elements may be present.

As used herein, in the specification, “a” or “an” may mean one or more, unless clearly indicated otherwise. As used herein, in the claim(s), when used in conjunction with the word “comprising,” the words “a” or “an” may mean one or more than one. As used herein “another” may mean at least a second or more.

In any disclosed aspect, the terms “about” and “approximately” and “substantially” and the like may be substituted with “within [a percentage] of” what is specified. In one non-limiting aspect, the percentage includes 0.1, 0.5, 1, 5, and 10 percent.

As used herein, unless the surrounding text explicitly indicates a contrary intention, all values given in the form of percentages are weight per weight (w/w), corresponding to the proportion of a particular substance within a mixture, as measured by weight or mass.

As used herein, pH values are those which can be obtained from any of a variety of potentiometric techniques employing a properly calibrated electrode.

It is specifically contemplated that any limitation discussed with respect to one embodiment of the disclosure may apply to any other embodiment of the disclosure. Furthermore, any composition of the disclosure may be used in any method of the disclosure, and any method of the disclosure may be used to produce or to utilize any composition of the disclosure.

Other objects, features, and advantages of the present disclosure will become apparent from the following detailed description. It should be understood, however, that the detailed description and the examples, while indicating specific aspects of the disclosure, are given by way of illustration only. Additionally, it is contemplated that changes and modifications within the spirit and scope of the disclosure will become apparent to those skilled in the art from this detailed description.

### BRIEF DESCRIPTION OF THE DRAWINGS

Various features and advantageous details are explained more fully with reference to the non-limiting aspects illustrated in the accompanying drawings and detailed in the following description. It should be understood, however, that the detailed description and the specific examples, while indicating aspects of the disclosure, are given by way of illustration only, and not by way of limitation. Various substitutions, modifications, additions, and/or rearrangements will become apparent to those of ordinary skill in the art from this disclosure.

FIG. 1 is a diagram depicting an egg yolk production process as disclosed herein in which a calcium salt is added to egg yolk prior to addition of enzymes to the egg yolk.

FIG. 2 is a diagram depicting an egg yolk production process as disclosed herein in which a calcium salt is added to egg yolk subsequent to addition of enzymes to the egg yolk.

FIG. 3 is a diagram depicting an egg yolk production process as disclosed herein in which a calcium salt and enzymes are concurrently added to egg yolk.

FIGS. 4A-4B. FIG. 4A is a graph depicting hen egg yolk pH changes at different calcium concentrations when hydrolyzed at 50° C. with PLA2 from A. niger. FIG. 4B is a graph depicting hen egg yolk pH changes using A. niger PLA2 and different calcium addition methods.

FIGS. 5A-5B. FIG. 5A is a graph depicting free fatty acid concentrations in liquid hen egg yolk upon hydrolysis with PLA2 at 50° C. in the presence of varying concentrations of calcium. FIG. 5B is a graph depicting free fatty acid concentrations in liquid hen egg yolk using A. niger PLA2 and different calcium addition methods.

FIG. 6 is a graph depicting hen egg yolk phospholipid hydrolysis rates when hydrolyzed at 122° C. with PLA2 from A. niger in the presence of varying concentrations of calcium.

### DETAILED DESCRIPTION

As noted above, the present disclosure provides methods for enhancing PLA2 activity to increase the rate of egg yolk phospholipid hydrolysis, increase the degree to which phospholipid fatty esters are hydrolyzed, and increase the concentration of free fatty acids in egg yolks. Lipids constitute approximately ⅓ of egg yolk (˜32-36% w/w), and approximately one-third of those lipids are phospholipids (˜28.3% w/w). Phospholipase-driven hydrolysis of phospholipid fatty esters to generate free fatty acids can increase the emulsion stability of egg yolk-inclusive food products. Enhancing the emulsifying properties of egg yolk can improve the performance of egg yolk-inclusive foods and reduce the egg yolk content requirement in processed foods such as dressings and mayonnaise-like products.

### I. Egg Yolk

Described herein are methods for making enzyme-modified egg yolk. In some aspects, enzyme-modified egg yolk acts as an emulsifier to promote the suspension of lipids in the aqueous phase of food products. In some aspects, enzyme-modified egg yolk stabilizes microstructures during frozen storage of food products. Accordingly, in some aspects, the enzyme-modified egg yolks disclosed herein can impart advantageous properties to foods, including improving the heat-stability and enhancing rheological properties and stability of egg yolk-inclusive emulsions. The egg yolk of the enzyme-modified egg yolk may be referred to as egg yolk matter, egg yolk material, or an egg yolk composition, and may include less than (i.e., a portion of), equal to, or greater than (i.e., more than one or portions of more than one) one egg yolk that is enzyme-modified as described herein.

Eggs are used in a variety of food ingredients and products. Egg ingredients for production traditionally have been in the form of whole (shell) eggs. However, alternatives to whole (shell) eggs include liquid and dried or powder egg products. In some aspects, liquid and dried or powder egg products can be treated with enzymes to improve their functionality and use.

Egg white, also known as albumen, is the clear, alkaline liquid portion of the egg surrounding the egg yolk. Egg white constitutes roughly two-thirds of a chicken egg by weight. Egg white includes 10-12% (w/w) protein as well as trace amounts of minerals, fats, vitamins, and carbohydrates carried in water. Slightly more than half of the protein content of eggs is contained in the egg white.

Egg yolk is a complex oil-in-water emulsion that includes about 50% water, 30-35% lipids and 15-20% protein. Egg yolk can include 25-30% phospholipids, which in some aspects, are useful in the manufacture of enzyme-modified egg yolk and finished goods manufactured therefrom. About 75% of the phospholipids in egg yolk are phosphatidylcholine, with the remaining phospholipids being, in descending order of prevalence, phosphatidylethanolamine, lysophosphatidylcholine, sphingomyelin, lysophosphatidylethanolamine, plasmalogen, and inositol phospholipid. The protein profile in egg yolk includes 65-70% low density lipoprotein (lipo-vitellin), 10-15% high density lipoprotein, 10-15% livetins, and 5-10% phosvitin. The majority of egg yolk proteins and lipids/phospholipids (i.e., greater than 50%) form lipoprotein complexes and micelles.

Due to the presence of various lipid and protein types in egg yolk, in some aspects, egg yolk has useful emulsifying and gelation properties. In some aspects, egg yolk can act as a natural emulsifier between fat and aqueous phases of a food product. Without wishing to be bound by theory, in some aspects, the emulsification activity of egg yolk is derived from its ability to reduce the surface energy between polar and non-polar components. For example, egg yolk contains surface-active components that include both hydrophobic and hydrophilic domains. These surface-active components can, in some aspects, stabilize an emulsion by forming an interfacial layer of water around the emulsion droplets. Such a water layer can provide kinetic stability of the emulsion to prevent migration of water or other polar materials away from the droplets and subsequent crystal growth during freeze-thaw cycles during storage and distribution.

In some aspects, enzyme-modified egg yolk can replace regular egg yolk in food products to, e.g., improve the microstructure and corresponding sensory attributes of the food products.

Typical initial yolk pH prior to adjustment is between pH 6.0-6.5 and yolk solid content is between 43% to 48%. Typical amount of 5N (18% w/w) sodium or potassium hydroxide needed to bring yolk pH to pH 8.05±0.25 at 50° C. ranges from 1.5% to 2.5% on yolk basis, more specifically 1.8% to 2.3% and most specifically 2.0% to 2.2% (yolk basis). The stock solution of this food grade base can be purchased at different concentrations, such as aforementioned 5N (18% w/w) or 30% (w/w) or 45% (w/w) and on. The stock food grade base solution can be diluted down to 1-10%, more specifically 2-8% and most preferably 3-4% (w/w) prior to being added into yolk for pH adjustment, while sufficient agitation can be maintained, so to avoid yolk protein denaturation thus gelling due to localized high pH exposure. The amount of basic solution needed to achieve pH 8.05±0.25 can vary depending on the initial pH of the yolk and the natural variation of its chemical composition as a biochemical matrix. Without wishing to be bound by theory, elevation of yolk temperature prior to pH adjustment to form the caustic intermediate is believed to enhance the susceptibility of the yolk proteins and protein-lipid complexes to subsequent enzymatic reactions and to interaction with other yolk components. In some aspects, the aqueous solution has a concentration (w/w) of about 1% to about 30% (e.g., at least, at most, exactly, or between any two of 1, 5, 10, 15, 20, 25, or 30%) of the GRAS base. In some aspects, the aqueous solution has a concentration (w/w) of about 4% to about 15% of the GRAS base. In some aspects, the aqueous solution has a concentration (w/w) of about 4% to about 7.5% of the GRAS base. In some aspects, the aqueous solution has a concentration (w/w) of about 4% to about 5% of the GRAS base. In some aspects, the aqueous solution of the GRAS base is added to the cooled yolk with appropriate agitation/mixing to avoid localized pH shock.

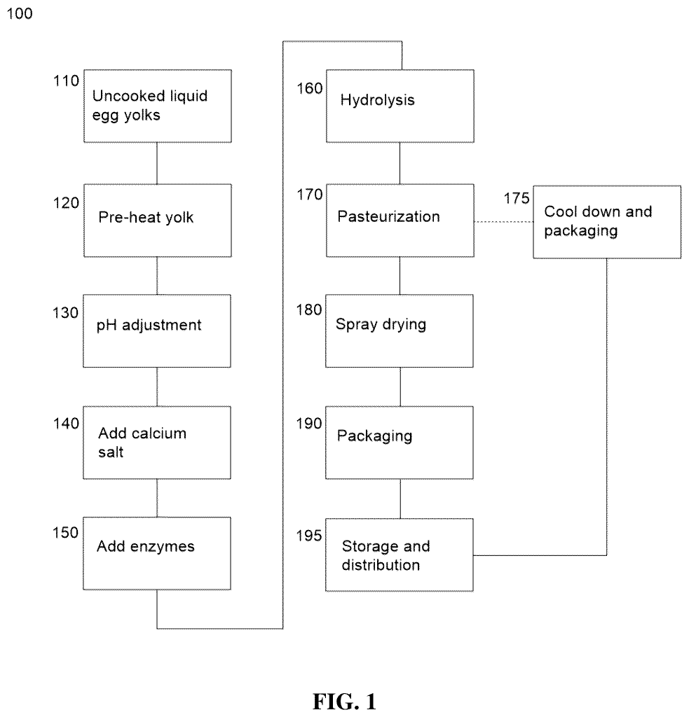

Reference is now made to FIG. 1, which is a simplified flowchart 100 of a method for producing an enzyme-modified egg yolk, in accordance with an aspect of the present disclosure. The method involves addition of calcium to egg yolks prior to addition of enzymes to the egg yolks. At first step 110, uncooked, liquid egg yolks are obtained. At step 120, the egg yolks are pre-heated. At step 130, the egg yolk pH is adjusted to a pH of from 7.8 to 8.1. A calcium salt is then added at step 140, followed by addition of PLA2 enzymes at step 150. At step 160, the enzymes hydrolyze phospholipid fatty esters to liberate the corresponding fatty acids. At step 170, the enzyme-modified egg yolk is then pasteurized. In some aspects, the enzyme-modified egg yolk can be pasteurized (e.g., by holding at about 87° C. for about 20 seconds) at step 170. In some aspects, pasteurization can be performed by any method known to those of skill in the art, e.g., indirect (tube-in-tube) or direct (steam injection). After pasteurization, the enzyme-modified egg yolk can optionally be cooled for storage and packaging at step 175. Alternatively, after pasteurization, the enzyme-modified egg yolk can be spray dried at step 180 followed by packaging at step 190. The packaged enzyme-modified egg yolks can then be stored and distributed at step 195.

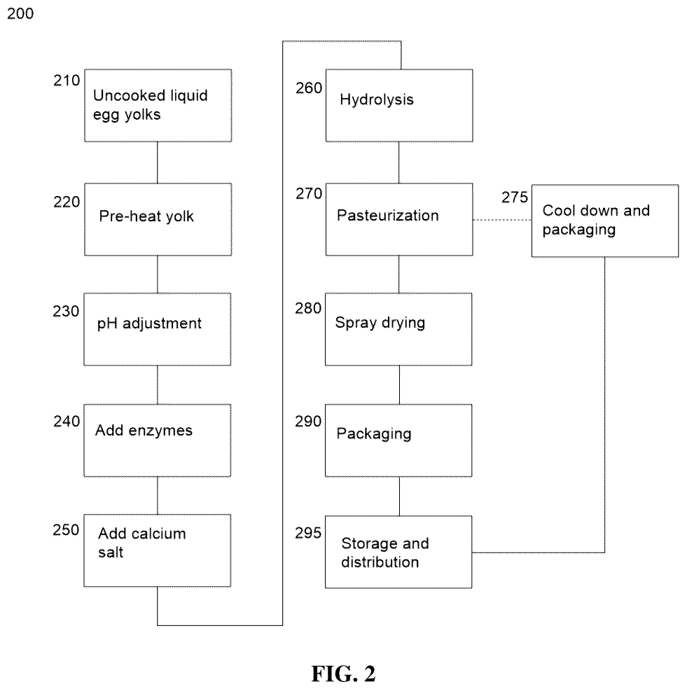

The simplified flow chart 200 in FIG. 2 represents an aspect of the present disclosure where calcium is added to egg yolks after addition of enzymes to the egg yolks. At first step 210, uncooked, liquid egg yolks are obtained. At step 220, the egg yolks are pre-heated. At step 230, the egg yolk pH is adjusted to a pH of from 7.8 to 8.1. At step 240, PLA2 enzymes are added to the egg yolk, followed by addition of a calcium salt at step 250. At step 260, the enzymes hydrolyze phospholipid fatty esters to liberate the corresponding fatty acids. At step 270, the enzyme-modified egg yolk is then pasteurized. After pasteurization, the enzyme-modified egg yolk can optionally be cooled for storage and packaging at step 275. Alternatively, after pasteurization, the enzyme-modified egg yolk can be spray dried at step 280 followed by packaging at step 290. The packaged enzyme-modified egg yolks can then be stored and distributed at step 295.

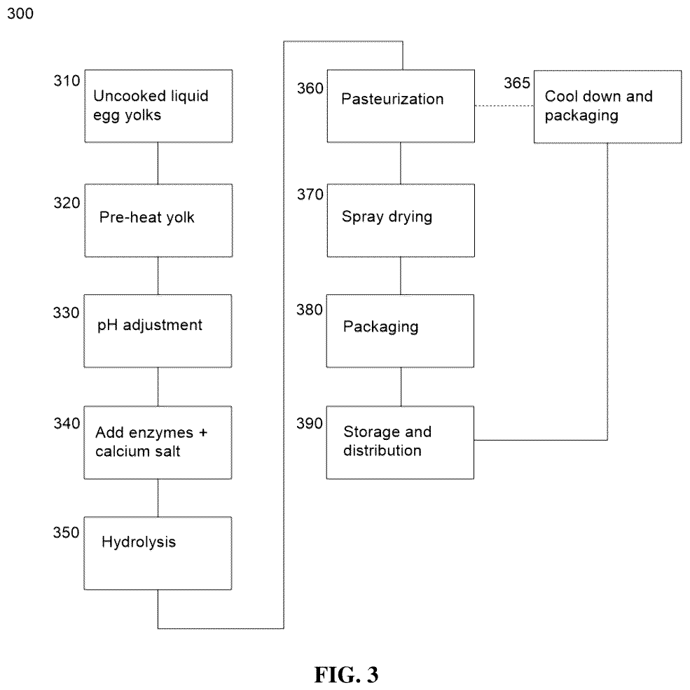

The simplified flow chart 300 in FIG. 3 represents an aspect of the present disclosure where calcium is added to egg yolks concurrently with enzymes. At first step 310, uncooked, liquid egg yolks are obtained. At step 320, the egg yolks are pre-heated. At step 330, the egg yolk pH is adjusted to a pH of from 7.8 to 8.1. At step 340, both calcium and PLA2 enzymes are added to the egg yolks concurrently. At step 350, the enzymes hydrolyze phospholipid fatty esters to liberate the corresponding fatty acids. At step 360, the enzyme-modified egg yolks are then pasteurized. After pasteurization, the enzyme-modified egg yolk can optionally be cooled for storage and packaging at step 365. Alternatively, after pasteurization, the enzyme-modified egg yolk can be spray dried at step 370 followed by packaging at step 380. The packaged enzyme-modified egg yolks can then be stored and distributed at step 390.

A method of producing an enzyme-modified egg yolk described herein can also include pasteurizing the enzyme-modified egg yolk, spray drying the enzyme-modified egg yolk so as to yield a powder version of the enzyme-modified egg yolk, and/or freezing the enzyme-modified egg yolk so as to yield a frozen version of the enzyme-modified egg yolk.

The enzyme-modified (e.g., hydrolyzed) egg yolk can be pasteurized by maintaining the yolk at a temperature of from about 65° C. to about 75° C. for a specified amount of time. In some aspects, the enzyme-modified (e.g., hydrolyzed) egg yolk can be pasteurized by maintaining the yolk at a temperature of from about 65° C. to about 72° C. In some aspects, the enzyme-modified (e.g., hydrolyzed) egg yolk can be pasteurized by maintaining the yolk at a temperature of from about 67° C. to about 72° C. In some aspects, the enzyme-modified (e.g., hydrolyzed) egg yolk can be pasteurized by maintaining the yolk at a temperature of from about 68° C. to about 72° C. These temperatures have been found to be sufficient to deactivate the PLA2 activity while eliminating pathogenic microorganisms of concern to ensure product safety and shelf stability.

The length of time at which the enzyme-modified (e.g., hydrolyzed) egg yolk is maintained at a specific temperature or temperature range for pasteurization depends on the particular temperature(s) employed for pasteurization but generally ranges from about 150 to about 600 seconds (e.g., at least, at most, exactly, or between any two of 150, 200, 250, 300, 350, 400, 450, 500 or 600 seconds). In some aspects, the enzyme-modified (e.g., hydrolyzed) egg yolk is maintained at a specific temperature or temperature range for pasteurization for about 400 to about 480 seconds. In some aspects, the enzyme-modified (e.g., hydrolyzed) egg yolk is maintained at a specific temperature or temperature range for pasteurization for about 410 to about 475 seconds. In some aspects, the enzyme-modified (e.g., hydrolyzed) egg yolk is maintained at a specific temperature or temperature range for pasteurization for about 250 to about 470 seconds. In some aspects, the enzyme-modified (e.g., hydrolyzed) egg yolk is maintained at a specific temperature or temperature range for pasteurization for about 420 to about 465 seconds. In one aspect, an exemplary time/temperature combination for pasteurization of the enzyme-modified (e.g., hydrolyzed) egg yolk is about 70° C. for about 450 seconds.

In some aspects, the enzyme-modified egg yolk, whether pasteurized or unpasteurized, is cooled below 5° C. In some aspects, the enzyme-modified egg yolk, whether pasteurized or unpasteurized, is cooled to about 4.5° C. The cooled enzyme-modified egg yolk can be stored at refrigerator or freezer temperatures if the cooled enzyme-modified egg yolk is to be used in liquid form. Alternatively, the cooled enzyme-modified egg yolk liquid can be spray dried so as to provide a powdered cooled enzyme-modified egg yolk.

The foregoing methods can produce an enzyme-modified (e.g., phospholipase-modified or hydrolyzed) egg yolk product that can act as an emulsifier to provide food products with improved stability, melt resistance, and shelf life compared to food products produced with conventional, unmodified egg yolk. The hydrolysis of position 2 ester bond between glycol backbone and the fatty acid results in improved polarity and flexibility of the resultant isophospholipids thus makes the molecular more prone to binding with both polar molecules and the non-polar molecules. Furthermore, the improved intra-molecular flexibility of isophospholipids makes it more tolerable to high energy motions such as those caused by elevated temperature and mechanical shearing and presented as overall improved emulsion stability when subjected to physical stresses. Accordingly, enzyme-modified egg yolk advantageously has improved emulsifying properties in the egg yolk itself, as well as an ability to stabilize otherwise incompatible ingredients.

### II. Enzymes

In some aspects, a food grade quality and regulatorily approved enzyme can be employed for the hydrolysis of egg yolk phospholipids. The enzyme may or may not be kosher and halal approved and certified and can be from different origins (e.g., animal and microbial). In some aspects, the enzyme is PLA2. In some aspects, the enzyme is specifically designed for food applications and catalyzes hydrolysis of the fatty acid in the second position of phospholipids or lecithin. PLA2 splits the fatty acid in position two of phospholipids, hydrolyzing the bond between the second fatty acid tail and the glycerol backbone. PLA2 is specific for the sn-2 acyl bond of phospholipids and catalytically hydrolyzes phospholipids exclusively at the 2-position, giving rise to the formation of 1-acyl-3-sn-lysophospholipids and free fatty acids. In some aspects, the enzyme is a phospholipase A2 enzyme in liquid form that is produced by DSM Food Specialists USA Inc. (Chicago, Illinois, USA), with a specified phospholipase A2 activity of 10500 Units/milliliter, and amylase activity less than 0.05 FAU/ml.

The enzyme can be obtained in liquid or dry form. If the enzyme is dried, in some aspects, the enzyme can be rehydrated in an excess of water, e.g., at w/w a ratio of from 1:2 to 1:10, of from 1:3 to 1:9, of from 1:4 to 1:8, or from 1:5 to 1:7. The enzyme can be used in liquid or dry form. In some aspects, no difference in hydrolysis effectiveness is observed between dried and rehydrated enzyme after addition into egg yolk. Liquid enzyme or an enzyme solution prepared from dried enzyme can be added to egg yolk with sufficient agitation to permit dispersion throughout the entirety of the container in which the egg yolk is held. During mixing, addition or incorporation of air to the yolk should be minimized. Relative to the amount of egg yolk, the weight percentage of the enzyme added ranges from 0.0125% to 0.1% (e.g., at least, at most, exactly, or between any two of 0.0125%, 0.0130%, 0.0135%, 0.0140%, 0.0145%, 0.0150%, 0.0155%, 0.0160%, 0.0165%, 0.0170%, 0.0175%, 0.0180%, 0.0185%, 0.0190%, 0.0195%, 0.0200%, 0.0210%, 0.0220%, 0.0230%, 0.0240%, 0.0250%, 0.0260%, 0.0270%, 0.0280%, 0.0290%, 0.030%, 0.0310%, 0.0320%, 0.0330%, 0.0340%, 0.0350%, 0.0360%, 0.0370%, 0.0380%, 0.0390%, 0.0400%, 0.0410%, 0.0420%, 0.0430%, 0.0440%, 0.0450%, 0.0460%, 0.0470%, 0.0480%, 0.0490%, 0.05%, 0.06%, 0.07%, 0.08%, 0.09%, 0.1%). In some aspects, 0.0200% to 0.0300% (w/w) enzyme (relative to yolk weight) is added. In some aspects, 0.0230% to 0.0270% (w/w) enzyme (relative to yolk weight) is added. Relative to the amount of egg yolk, the weight in grams of enzyme added ranges from 0.000125 g to 0.001 g (e.g., at least, at most, exactly, or between any two of 0.000125 g, 0.000130 g, 0.000135 g, 0.000140 g, 0.000145 g, 0.000150 g, 0.000155 g, 0.000160 g, 0.000165 g, 0.000170 g, 0.000175 g, 0.000180 g, 0.000185 g, 0.000190 g, 0.000195 g, 0.000200 g, 0.000210 g, 0.000220 g, 0.000230 g, 0.000240 g, 0.000250 g, 0.000260 g, 0.000270 g, 0.000280 g, 0.000290 g, 0.00030 g, 0.000310 g, 0.000320 g, 0.000330 g, 0.000340 g, 0.000350 g, 0.000360 g, 0.000370 g, 0.000380 g, 0.000390 g, 0.000400 g, 0.000410 g, 0.000420 g, 0.000430 g, 0.000440 g, 0.000450 g, 0.000460 g, 0.000470 g, 0.000480 g, 0.000490 g, 0.0005 g, 0.0006 g, 0.0007 g, 0.0008 g, 0.0009 g, 0.001 g). In some aspects, 0.0250% (w/w) enzyme (relative to yolk weight) or 0.00025 g of enzyme per gram of liquid egg yolk is added. In some aspects, the amount of enzyme added is based on target enzyme activity units per gram of liquid egg yolk. In some aspects, 2.625 enzyme activity units per gram of liquid egg yolk is added.

During enzymatic modification of egg yolks, phospholipids are converted into free fatty acids and stable lysophospholipids (“LPLs”) to produce enzyme-modified egg yolk. Non-limiting examples of LPLs include lysophosphatidylcholine, lysophosphatidylethanolamine and lysophosphatidaylserine lysophosphatidic acid (radyl-lyso-glycerophosphate, LPA), 2,3-cyclic phosphatidic acid, 1-alkyl-2-acetyl-glycero-3-phosphate, sphingosine-1-phosphate (SIP), dihydro-sphingosine-1-phosphate, sphingosylphosphorylcholine (lysosphingomyelin, SPC), and lysophosphatidylcholine (LPC). Without wishing to be bound by theory, in some aspects, LPLs can provide enhanced emulsification relative to their phospholipid precursors due to increased hydrophilicity and molecular flexibility. The increased hydrophilicity and molecular flexibility of LPLs compared to phospholipid precursors can inhibit breakage of emulsions (either oil-in-water or water-in-oil) that causes oil(s) to separate, fat globule flocculate, rupture of air cells (such as in the cases of ice cream microstructures) and form large clusters. LPLs also tend to be more stable at or when exposed to elevated temperatures. Accordingly, in some aspects, LPLs generated from the enzymatic modification of egg yolk can, for example, permit high temperature pasteurization/retort to improve microbiological safety and product shelf life.

Monitoring of the yolk pH and free fatty acid concentration can help to determine the degree of yolk phospholipid hydrolysis, which can vary somewhat based on the desired product functionality. In the industry, a common way to indicate degree of hydrolysis is by measuring the amount of free fatty acid. Fatty acids liberated through enzymatically-catalyzed hydrolysis of the yolk phospholipids are converted to free fatty acid, and the total amount of free fatty acids is measured to determine the degree of yolk hydrolysis. The amount of free fatty acid in powdered enzyme-modified egg yolk does not differ significantly from the amount in liquid enzyme-modified egg yolk. Although the degree of yolk hydrolysis may be measured and reported herein according to the total amount of free fatty acids in the yolk, the degree of yolk hydrolysis may also be reported by converting and presenting the amount of free fatty acids as a percentage of oleic acid, as is customary in the industry. Accordingly, in any of the aspects disclosed herein, the free fatty acids of the enzyme-modified egg yolk can be measured in oleic acid equivalents. Oleic acid is an abundant and important unsaturated fatty acid with well documented nutritional significance.

Non-enzyme treated (i.e., unmodified) egg yolk usually has a free fatty acid content (in oleic acid equivalents) of from about 0.7% to about 1.8% (w/w), varying based on breed, feed, and growth conditions. In some aspects, prior to final (full) pasteurization, the enzyme-modified egg yolk produced according to the methods described herein includes a free fatty acid content (in oleic acid equivalents) of from about 2% to about 15% (w/w) (e.g., at least, at most, exactly, or between any two of 1.0%, 2.5%, 5%, 7.5%, 10%, 12.5%, or 15%). In some aspects, enzyme-modified egg yolk produced includes a free fatty acid content (in oleic acid equivalents) of from about 4% to about 10% (w/w). In some aspects, enzyme-modified egg yolk produced includes a free fatty acid content (in oleic acid equivalents) of from about 4% to about 8% (w/w). In some aspects, enzyme-modified egg yolk produced includes a free fatty acid content (in oleic acid equivalents) of from about 5% to about 7% (w/w).

In some aspects, phospholipid hydrolysis by a phospholipase (e.g., a phospholipase A2) proceeds until the egg yolk comprises greater than or equal to 2% (w/w) free fatty acids (in oleic acid equivalents) to provide an enzyme-modified egg yolk having greater than or equal to 2% (w/w) free fatty acids (in oleic acid equivalents). In some aspects, the enzyme (e.g., a phospholipase) is deactivated by a cold treatment by cooling or allowing a mixture comprising a phospholipase to cool. In some aspects, the enzyme is deactivated by heating, which can be performed in combination within the liquid final pasteurization process step. In some aspects, the enzyme (e.g., a phospholipase) is deactivated after the egg yolk comprises a free fatty acid content (in oleic acid equivalents) of from about 2% to about 15% (w/w) (e.g., at least, at most, exactly, or between any two of 1.0%, 2.5%, 5%, 7.5%, 10%, 12.5%, or 15%). In some aspects, the enzyme (e.g., a phospholipase) is deactivated after the egg yolk comprises a free fatty acid content (in oleic acid equivalents) of from about 4% to about 10% (w/w). In some aspects, the enzyme (e.g., a phospholipase) is deactivated after the egg yolk comprises a free fatty acid content (in oleic acid equivalents) of from about 4% to about 8% (w/w). In some aspects, the enzyme (e.g., a phospholipase) is deactivated after the egg yolk comprises a free fatty acid content (in oleic acid equivalents) of from about 5% to about 7% (w/w).

### III. Food Products

Disclosed herein, in some aspects, are food products including enzyme-modified egg yolk. In some aspects, inclusion of enzyme-modified egg yolk in the food products can provide food products that are superior to conventional food products formulated with unmodified egg yolk. For example, food products formulated with enzyme-modified egg yolk can have improved overall quality, particularly microstructural and/or textural quality and mouthfeel compared to conventional food products formulated with unmodified egg yolk. Inclusion of enzyme-modified egg yolk in the food products can yield creamier, fuller, and better tasting food products due to improved stability and enhanced flavor releasing properties provided, at least in part, by the enzyme-modified egg yolk. Food products formulated with enzyme-modified egg yolk can also have a longer product shelf life than conventional food products formulated with unmodified egg yolk due to the significantly slower growth rate of crystals of water soluble components thus the improved microstructural quality and smoother and fuller mouthfeel. This can reduce product loss and allow more products to be sold for a significantly longer period of shelf life without significant sandy or rough mouthfeel. Premium food products formulated with enzyme-modified egg yolk having improved microstructural and/or textural quality and mouthfeel may also yield a higher profit margin compared to conventional food products formulated with unmodified egg yolk.

Egg yolk can be key ingredient in food products due to its good stabilizing and emulsifying properties which are provided by phospholipids and hydrolyzed or free fatty acids. Non-limiting examples of food products that may include the enzyme-modified egg yolk disclosed herein are bakery food products (e.g., cakes, bread, muffins, pancakes), frozen dessert products (e.g., sorbet and water ices, dairy products such as ice cream, ice milk, sherbet, custard, mousse, gelato, frozen yogurt, soft serve ice cream, and milk shakes, and specialty items such as bars, cones, and sandwiches), mayonnaise, salad dressings, and other food products. Egg yolk as in whole or its components can have a profound effect on gel formation, which involves formation of a multidimensional network of proteins when egg yolk when heated. In addition to the taste and nutritional value, enzyme-modified egg yolk can contribute as a foaming agent, an emulsifier, and a bonding agent (adding cohesiveness to the overall structure). As an emulsifier, the enzyme-modified egg yolk can facilitate the mixing or dispersion of the ingredients. The cohesiveness that the enzyme-modified egg yolk contributes relates its ability to act as a “glue” or bonding agent to maintain the food product as a foam structure.

The food products disclosed herein may also include one or more additional emulsifiers/stabilizers, one or more additives, one or more flavorings, one or more vitamins, or combinations thereof. The food products disclosed herein may also include starch(es), oil(s), fat(s), colorant(s), flavoring(s), preservative(s), or water, or any combination thereof.

Non-limiting examples of additional emulsifiers/stabilizers that may be included in the food products disclosed herein include monoglycerides, locust bean gum, guar gum, carrageenan, or combinations thereof. Non-limiting examples of additives that may be included in the food products disclosed herein include alternative or additional flavoring and/or coloring agents, vitamins, alternative or additional sweeteners, and acidifying agents. Many different flavoring agents may be included in the food products disclosed herein. The flavoring agents may be natural or non-natural. Vitamins can be included in the food products disclosed herein. Vitamins may include any of vitamin A, a vitamin A derivative, a vitamin B, a vitamin B derivative, vitamin C, a vitamin C derivative, vitamin D, a vitamin D derivative, vitamin E, a vitamin E derivative, vitamin F, a vitamin F derivative, vitamin K, a vitamin K derivative, thiamine, riboflavin, niacin, vitamin B6, folate, vitamin B12, biotin, and pantothenic acid. Any one or more of the foregoing emulsifiers/stabilizers, additives, flavorings, vitamins or combinations thereof may be excluded from the present food products.

Starches are available from a variety of botanical sources, and native and modified forms of starches are contemplated for use in food products. The starches can be natural, non-processed starches or physically processed starches. The starches can have a bulk density of below 50 g/100 ml, e.g., a bulk density from 8-40 g/100 ml, from 10-30 g/100 ml, or from 11-20 g/100 ml. In some aspects, the one or more starches are pea starch, corn starch, rice starch, potato starch, wheat starch, or tapioca starch, or any combination thereof. Any one or more of the foregoing starches may be excluded from the food products disclosed herein. Starches can act as fillers and enhance texture via their ability to bind and retain moisture. When heated in the presence of water, gelatinization can occur when the starch granules swell, entrapping the water released from the textured protein or other components of the composition. Starch selection for food product formulation may be dependent on the needed functionality and how the product is prepared, and one of skill in the art would understand starch properties to select the appropriate starch for the food product.

Fats or oils can contribute to the perceived tenderness and juiciness of the product and can aid in flavor retention/release. Liquid oils can contribute lubricity and add in the consumer perception of moisture, while saturated fats can contribute firmness to a chilled mix of a food product. Flaked solid fat can also add the expected appearance of marbling. Fats or oils can be pre-emulsified and introduced together with other ingredients in a mixing step. Additionally, or alternatively, fat or oils can be introduced through mixing the fats or oils with the pre-processed ingredients in a cold mixing step to create the final product. Additionally, or alternatively, fats or oils can be injected into the formed food product. In some aspects, the fats or oils include vegetable oil, coconut oil, palm oil, or cocoa butter, or any combination of soy, sunflower, rapeseed, canola, corn, palm, coconut, vegetable, cocoa, and sesame oil. The right combination of fats is important to achieve a desirable succulent mouthfeel and lingering flavor, and one of skill in the art would understand fat and oil properties to select the appropriate fat(s) and/or oil(s) for the food product.

Color may be a factor in the visual appeal of the food product. Colorants may be any dye, pigment, or substance that imparts color when it is added to food. They can be supplied as liquids, powders, gels, or pastes. Colorants may be natural (e.g., carotenoids, chlorophyllin, anthocyanins, betanin, annatto. caramelized sugar, carmine, elderberry juice, lycopene, paprika, turmeric/curcumin, etc.) or synthetic (e.g., FD&C Blue No. 1, FD&C Blue No. 2, FD&C Green No. 3, FD&C Red No. 3, FD&C Red No. 40, FD&C Yellow No. 5, FD&C Yellow No. 6, etc.). One of skill in the art would understand colorant properties to select the appropriate colorants for the food product.

The flavor and taste of products can be important, as they determine the overall consumer acceptability of the finished product. To attain flavors and aromas, reducing sugars (glucose, xylose, fructose, and ribose), hydrolyzed vegetable proteins, amino acids (cysteine, cystine, lysine, methionine, proline, serine, threonine), vitamins (such as thiamine), nucleotides, and iron complexes (e.g., ferrous chlorophyllin or heme-containing proteins) may be used. Other flavorings may include one or more salts, spices, herbs, or vegetables (e.g., onions, celery, peppers, etc.). One of skill in the art would understand flavoring properties to select the appropriate flavorings for the food product.

Water can act as a hydration medium for the different dried ingredients and as a plasticizer and reaction agent during processing. In extrusion processing, for example, water can determine the viscosity of the melt, participate in the chemical reactions, influence the friction, and/or act as an energy transfer medium. Disulfide bonds, hydrogen bonds, and hydrophobic interactions may be promoted at higher moisture levels, which can lead to a high degree of fibrous structure formation. In addition, functional properties of the food products including swelling, viscosity, gelation, emulsification, and foaming may be affected by the availability of water in the food product. In some aspects, water content may contribute to sensory properties such as juiciness and mouthfeel. The inclusion of water in food may also reduce ingredient costs.

Preservatives may be natural and may comply with clean labeling requirements. For example, preservatives may include citric acid, one or more vinegars produced from natural fermentation, or other organic acids, peptides, or salts derived from cultured fruits and/or vegetables, cultured dextrose, cultured wheat, cultured whey, cultured brown rice, etc. Preservatives can also include artificial preservatives such as nitrates, sulfites, benzoates (or sodium benzoate), propylene glycol, butylated hydroxyanisole (BHA), carrageenan, etc. One of skill in the art would understand preservative properties to select the appropriate preservatives for the food product.

### EXAMPLES

The following examples are included to demonstrate preferred embodiments of the disclosure. It should be appreciated by those of skill in the art that the techniques disclosed in the following examples represent techniques discovered by the inventor to function well in the practice of the disclosure, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1

### Batch Addition of Calcium Before Addition of Enzyme

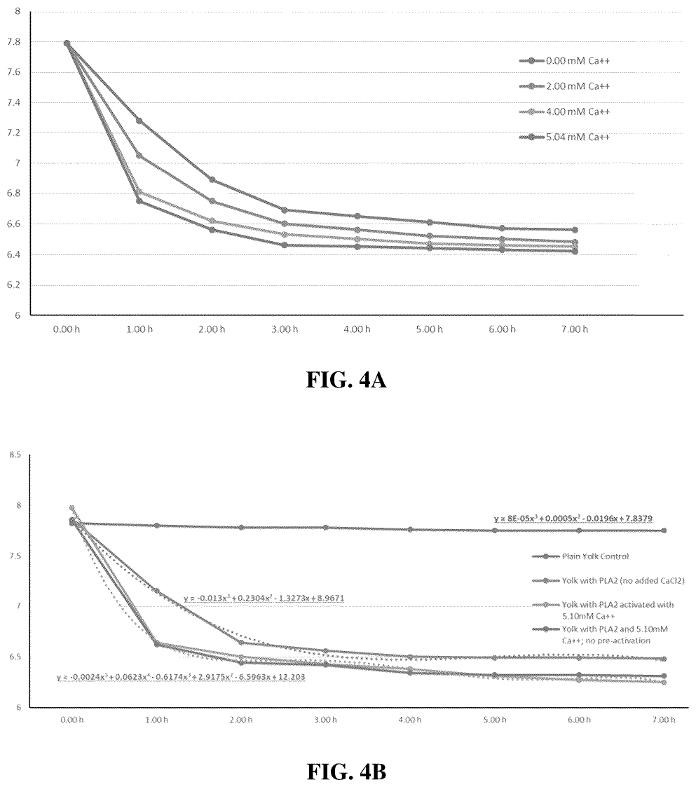

Uncooked liquid hen egg yolk was supplemented with calcium during PLA2 hydrolysis. Uncooked liquid egg yolk was preheated at 55.6 to 65.6° C. for 3.5 to 5.5 minutes. The egg yolk pH was adjusted to a pH range of 7.8 to 8.1 using a solution of sodium hydroxide at a concentration of 2 to 40 w/w % while being agitated. An aqueous solution of CaCl₂) at a concentration of 0.5 to 74.5% w/w was added to the pH-adjusted egg yolk. The target calcium concentration levels in the pH-adjusted egg yolk were 0, 2.0, 4.0, and 5.04 mM. The pH decreased in a dose-dependent manner based upon the amount of added calcium (FIG. 4A). A nominal difference in egg yolk pH was observed for PLA2-treated egg yolks that were pre-incubated with calcium as compared to pH of PLA2-treated yolk pH when prepared with no pre-incubation of PLA2 with calcium (FIG. 4B). PLA2 enzyme in liquid form was added with agitation to allow the enzyme to disperse evenly throughout the egg yolk. The egg yolk was then heated to a temperature ranging from 43.3 to 54.5° C. and the egg yolk's pH and free fatty acid concentration were monitored to determine the degree of hydrolysis. When the desired free fatty acid concentration was reached, hydrolysis was ended by cooling the egg yolk to 4.5° C. to inhibit PLA2 activity.

### Example 2

Batch Addition of Calcium after Addition of Enzyme

Uncooked liquid hen egg yolk was supplemented with calcium during PLA2 hydrolysis. Uncooked liquid egg yolk was preheated at 55.6 to 65.6° C. for 3.5 to 5.5 minutes. The egg yolk pH was adjusted to a pH range of 7.8 to 8.1 using a solution of sodium hydroxide at a concentration of 2 to 40 w/w % while being agitated. PLA2 enzyme in liquid form was added with agitation to allow the enzyme to disperse evenly throughout the egg yolk. An aqueous solution of CaCl₂) at a concentration of 0.5 to 74.5% w/w was added in a single batch to the pH-adjusted egg yolk. The egg yolk was then heated to a temperature ranging from 43.3 to 54.5° C. and the egg yolk's pH and free fatty acid concentration were monitored to determine the degree of hydrolysis. When the desired free fatty acid concentration was reached, hydrolysis was ended by cooling the egg yolk to 4.5° C. to inhibit PLA2 activity.

### Example 3

Periodic Addition of Calcium after Addition of Enzyme

Uncooked liquid hen egg yolk was supplemented with calcium during PLA2 hydrolysis. Uncooked liquid egg yolk was preheated at 55.6 to 65.6° C. for 3.5 to 5.5 minutes. The egg yolk pH was adjusted to a pH range of 7.8 to 8.1 using a solution of sodium hydroxide at a concentration of 2 to 40 w/w % while being agitated. PLA2 enzyme in liquid form was added with agitation to allow the enzyme to disperse evenly throughout the egg yolk. An aqueous solution of CaCl₂) at a concentration of 0.5 to 74.5% w/w was added periodically at time points of 0 hours, 1 hour, 2 hours, and 3 hours to the pH-adjusted egg yolk. The egg yolk was then heated to a temperature ranging from 43.3 to 54.5° C. and the egg yolk's pH and free fatty acid concentration were monitored to determine the degree of hydrolysis. When the desired free fatty acid concentration was reached, hydrolysis was ended by cooling the egg yolk to 4.5° C. to inhibit PLA2 activity.

### Example 4

Continuous Addition of Calcium after Addition of Enzyme

Uncooked liquid hen egg yolk was supplemented with calcium during PLA2 hydrolysis. Uncooked liquid egg yolk was preheated at 55.6 to 65.6° C. for 3.5 to 5.5 minutes. The egg yolk pH was adjusted to a pH range of 7.8 to 8.1 using a solution of sodium hydroxide at a concentration of 2 to 40 w/w % while being agitated. PLA2 enzyme in liquid form was added with agitation to allow the enzyme to disperse evenly throughout the egg yolk. An aqueous solution of CaCl₂) at a concentration of 0.5 to 74.5% w/w was added continuously using an inline injection system at a fixed injection rate to the pH-adjusted egg yolk. The egg yolk was then heated to a temperature ranging from 43.3 to 65.6° C. and the egg yolk's pH and free fatty acid concentration were monitored to determine the degree of hydrolysis. When the desired free fatty acid concentration was reached, hydrolysis was ended by cooling the egg yolk to 4.5° C. to inhibit PLA2 activity.

### Example 5

Variable Addition of Calcium after Addition of Enzyme

Uncooked liquid hen egg yolk was supplemented with calcium during PLA2 hydrolysis. Uncooked liquid egg yolk was preheated at 55.6 to 65.6° C. for 3.5 to 5.5 minutes. The egg yolk pH was adjusted to a pH range of 7.8 to 8.1 using a solution of sodium hydroxide at a concentration of 2 to 40 w/w % while being agitated. PLA2 enzyme in liquid form was added with agitation to allow the enzyme to disperse evenly throughout the egg yolk. An aqueous solution of CaCl₂) at a concentration of 0.5 to 74.5% w/w was added continuously using an inline injection system at a variable-rate, ramped injection to the pH-adjusted egg yolk. The egg yolk was then heated to a temperature ranging from 43.3 to 54.5° C. and the egg yolk's pH and free fatty acid concentration were monitored to determine the degree of hydrolysis. When the desired free fatty acid concentration was reached, hydrolysis was ended by cooling the egg yolk to 4.5° C. to inhibit PLA2 activity.

### Example 6

### Spray Drying to Produce Enzyme-Modified Yolk Powder

The finished enzyme-modified egg yolks were spray dried to provide enzyme-modified yolk powder. The liquefied egg yolk prepared as described above according to one Examples 1 to 6 was diluted in distilled water (50% w/w egg yolk/water) then shaken to break down agglomerates and to facilitate pumping into the spray dryer. 5 L of unpasteurized liquid egg mixture at room temperature (10° C.) was fed into the spray dryer under constant stirring at 200 rpm. The air pressure at the spray dryer compressor outlet was maintained at 88 pounds per square inch (psi). The relative humidity of the drying air was in the range of 53-70%. The flow rate of the spraying air was set at 29 ft³/h. The liquid egg feed pump was set at 10%. The inlet air temperature was set at 120° C. The resulting outlet air temperature was in the range of 73.9 to 76.7° C. The enzyme-modified egg yolks were spray dried then stored in hermetically sealed bags for subsequent analysis.

### Example 7

### Analysis of Dried Enzyme-Modified Yolk Powder

The hydrolyzed yolk powders prepared by the methods described in Examples 1 to 6 were analyzed. Egg yolk powders prepared with addition of calcium had detectably higher calcium concentration as compared to egg yolk powders produced without addition of calcium. In the case of spray dried powder finished product, test samples (with added calcium chloride) had a calcium concentration higher than 316 mg/100 g, which is the maximum level of calcium concentration in dried egg yolk powder products dictated by the United States Department of Agriculture's Agricultural Research Service, which states that calcium content in dried egg yolk powder products can range from 168 mg/100 g to 316 mg/100 g, with a typical concentration of 289 mg/100 g. Mean calcium content in the finished spray dried enzyme modified yolk powder using the methods disclosed herein is 351 mg/100 g, with the calcium concentration ranging from 346 mg/100 g to 351 mg/100 g. The control samples, which did not have added calcium chloride for PLA2 improvement, had a mean concentration of 300 mg/100 g with the calcium concentration ranging from 299 mg/100 g to 304 mg/100 g. For comparison, a non-enzyme-modified standard yolk powder has a calcium content ranging from 309 mg/100 g to 314 mg/100 g, which is at the upper end of USDA surveyed range of standard dried egg yolk powder.

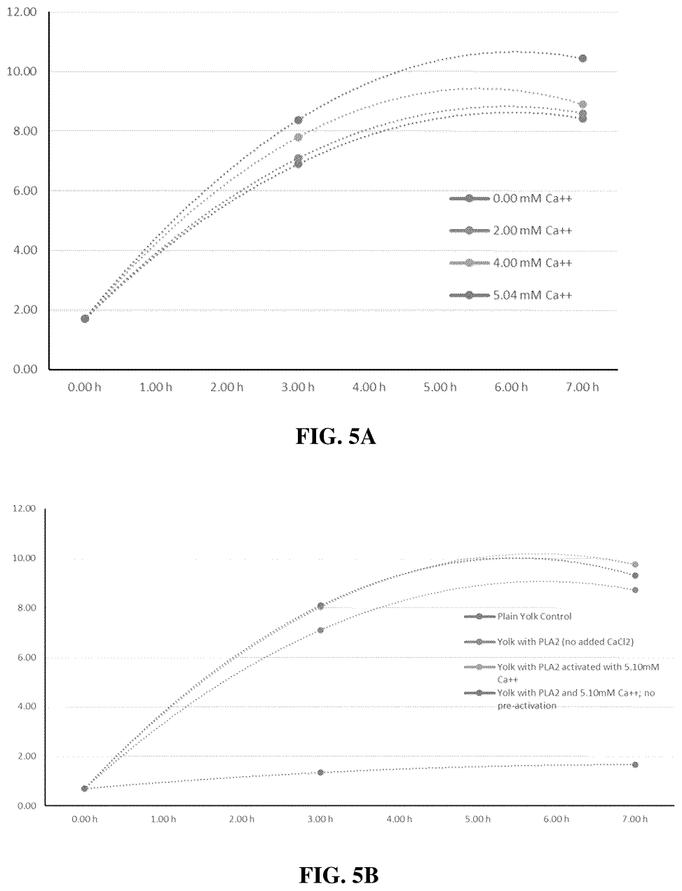

A calcium concentration-dependent increase in free fatty acid content was observed for enzyme-modified egg yolks (FIG. 5A). A nominal difference in free fatty acid content was observed for PLA2-treated egg yolks that were pre-incubated with calcium as compared to free fatty acid content of PLA2-treated yolk pH when prepared with no pre-incubation of PLA2 with calcium (FIG. 5B). Both the samples pre-incubated and incubated with calcium had higher free fatty acid content than the egg yolk sample that was treated with PLA2 with no added calcium (FIG. 5B), thereby demonstrating a correlation between added calcium and increased free fatty acid content (and increased phospholipid hydrolysis).

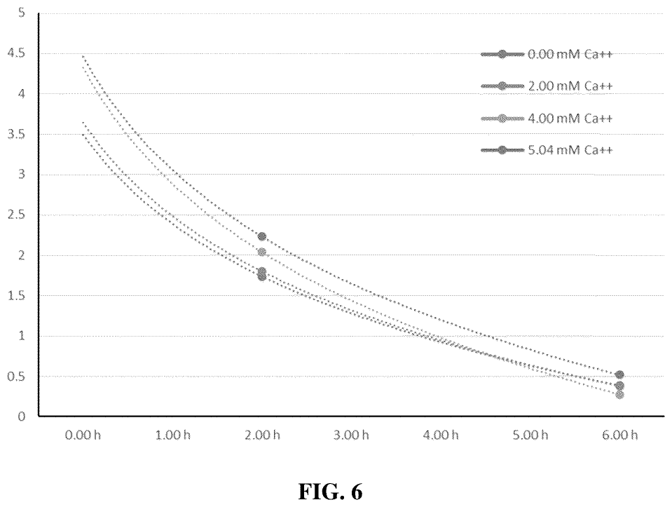

In an analysis of egg yolk hydrolysis rate (FIG. 6), the use of increasing concentrations of calcium increased phospholipid hydrolysis rate at a 2-hour time point. These results confirm that, in some aspects, the use of PLA2 in conjunction with supplemented calcium leads to increased hydrolysis of phospholipid fatty acids, increased phospholipid hydrolysis rates, and increased free fatty acid content in enzyme-modified egg yolks.

The methods disclosed herein can achieve reduce processing time, from 5 to 7 hours for current industrial practice, to only 3 hours, based on free fatty acid measurement. In terms of pH measurement, the methods disclosed herein can achieve a pH drop in 3 hours that otherwise requires 6.5 hours of hydrolysis time when processed using current industrial practices. The methods disclosed herein can significantly improve phospholipid-hydrolysis activity of PLA2, thereby significantly reducing hydrolysis time. Hydrolysis time can be reduced by 40% to 50%, from 5.0 hours to 3.0 hours based on free fatty acid tests, or from 6.5 hours to 3.0 hours based on pH measurements. When applied in conjunction with mayonnaise production, the methods disclosed herein reduced hydrolysis time from 6.5 hours for a conventional method to 3.0-hours, a reduction of greater than 50%.

The methods disclosed herein allow manufacturers better control over egg yolk hydrolysis processing and allow manufacturers to achieve higher degrees of hydrolysis without having to extend hydrolysis time. The methods disclosed herein allow manufacturers to differentiate their improved-functionality products from competitors' products based on the calcium concentration of the enzyme-modified egg yolk products. The methods disclosed herein allow manufacturers to meet customers' broader functionality demands, such as a higher degree of hydrolysis, more stable yolk proteins, creamier mouthfeel, and better product storage stability. The methods disclosed herein also significantly reduce egg yolk hydrolysis time, thereby reducing overall production costs.

The above specification and examples provide a complete description of the structure and use of illustrative embodiments. Although certain aspects have been described above with a certain degree of particularity, or with reference to one or more individual aspects, those skilled in the art could make numerous alterations to the disclosed aspects without departing from the scope of this disclosure. As such, the various illustrative aspects of the methods and systems are not intended to be limited to the particular forms disclosed. Rather, they include all modifications and alternatives falling within the scope of the claims, and aspects other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one aspect or may relate to several aspects.

1. A method of producing enzyme-modified egg yolk, the method comprising incubating a phospholipase, a calcium salt, and egg yolk for a time sufficient to hydrolyze phospholipids in the egg yolk to yield the enzyme-modified egg yolk.

2. The method of claim 1, further comprising, prior to incubating the phospholipase, the calcium salt, and the egg yolk:
incubating the calcium salt with the phospholipase;
incubating the calcium salt with the egg yolk; or
incubating the phospholipase with the egg yolk.

3. The method of claim 2, wherein the calcium salt and the phospholipase are incubated for 5 minutes to 120 minutes prior to incubating the phospholipase, the calcium salt, and the egg yolk.

4-7. (canceled)

8. The method of claim 2, wherein incubating the phospholipase, the calcium salt, and the egg yolk includes periodically adding the calcium salt to the phospholipase and the egg yolk.

9. The method of claim 2, wherein incubating the phospholipase, the calcium salt, and the egg yolk includes continuously adding the calcium salt to the phospholipase and the egg yolk.

10. The method of claim 1, wherein the calcium salt is added to the egg yolk at a calcium concentration ranging from 2.0 to 50 mM salt.

11. (canceled)

12. The method of claim 1, wherein the phospholipase, the calcium salt, and the egg yolk are incubated at a temperature of 43° C. to 55° C. for 1 hour to 6 hours.

13-14. (canceled)

15. The method of claim 1, further comprising heating the egg yolk to a temperature of 55° C. to 67° C. for 2.0 min to 8.0 min prior to incubating the phospholipase, the calcium salt, and the egg yolk.

16-18. (canceled)

19. The method of claim 1, further comprising adjusting the pH of the egg yolk.

20. The method of claim 19, wherein the egg yolk pH is adjusted to pH 7.8 to pH 8.1.

21-22. (canceled)

23. The method of claim 20, wherein the egg yolk pH is adjusted after heating the egg yolk and prior to incubating the phospholipase, the calcium salt, and the egg yolk.

24. The method of claim 1, further comprising deactivating the phospholipase after the egg yolk includes greater than or equal to 2% (w/w) free fatty acids.

25-26. (canceled)

27. The method of claim 1, wherein the calcium salt is selected from the group consisting of calcium chloride, calcium acetate, calcium nitrate, calcium lactate, calcium glucoronate, and calcium bicarbonate.

28. The method of claim 1, further comprising spray-drying or freezing the enzyme-modified egg yolk.

29. An enzyme-modified egg yolk produced according to the method of claim 1.

30. The enzyme-modified egg yolk of claim 29, wherein the enzyme-modified egg yolk includes greater than or equal to 2% (w/w) free fatty acids and greater than or equal to 320 mg of calcium per 100 g of the enzyme-modified egg yolk.

31. The enzyme-modified egg yolk of claim 29, wherein the enzyme-modified egg yolk is dried.

32. A food product comprising the enzyme-modified egg yolk of claim 29.

33. An enzyme-modified egg yolk comprising greater than or equal to 2% (w/w) free fatty acids and greater than or equal to 320 mg of calcium per 100 g of the enzyme-modified egg yolk.

34. The enzyme-modified egg yolk of claim 33, wherein the enzyme-modified egg yolk is dried.
